(19) United States
(12) Patent Application Publication
(10) Pub. No.: US 2014/0304650 A1
(43) Pub. Date: Oct. 9, 2014

(54) INFORMATION PRESENTATION CORRESPONDING TO CONTENT PURPOSING MASKS

(71) Applicants: Carol Linburn, San Francisco, CA (US); Winston L. Wang, Santa Clara, CA (US); Simon Hayhurst, Palo Alto, CA (US)

(72) Inventors: Carol Linburn, San Francisco, CA (US); Winston L. Wang, Santa Clara, CA (US); Simon Hayhurst, Palo Alto, CA (US)

(73) Assignee: Adobe Systems Incorporated, San Jose, CA (US)

(21) Appl. No.: 11/747,012

(22) Filed: May 10, 2007

(51) Int. Cl. G06F 3/048

(52) U.S. Cl. 715/810

(57) ABSTRACT

An integrated development environment (IDE) feature is described that provide relevant information regarding the various purposing masks in an intuitive manner. A user selects one or more target media types for the content being worked on in the IDE. When these target media are selected, masks corresponding to the selected target media are displayed over the content. The IDE monitors the position information identifying a display location of each mask. When the user performs some kind of information event associated with an identified display location of one of the masks, the IDE detects this event and displays an information box that contains media type information regarding the target media related to the specific mask at the identified display location.

### CROSS-REFERENCE TO RELATED APPLICATIONS

The present application is related to co-pending and commonly-assigned U.S. patent application Ser. No. 11/512,567, Attorney Docket No. B266, entitled “IDENTIFICATION OF COMMON VISIBLE REGIONS IN PURPOSING MEDIA FOR TARGETED USE” the disclosure of which is hereby incorporated herein by reference.

### TECHNICAL FIELD

The present invention relates, in general, to media development environments, and, more specifically, to providing rollover information for media purposed for a specific use.

### BACKGROUND OF THE INVENTION

In today's information-driven world, it is often desirable to present information in various different media. “Media” or “medium” as used herein, refers to any mechanism for presenting content. Examples of media include non-electronic media such as paper, etc on which content may be presented (e.g., content may be printed, painted, or otherwise presented on such non-electronic media). A further example of media includes electronic media, such as electronic devices operable to display content stored on a computer readable medium, etc. Content refers to any type of information that may be present on a media, such as images (still, moving, video, etc), text, etc.

Content created by a content author, such as a designer, developer, programmer, graphic artist, and the like, may be created specifically for presentation on multiple different devices or in multiple different formats. These different displays and formats may have several different presentation variables, such as display size, aspect ratio, resolution, size, pixel shape and size, and the like. The content author would generally create. reshape, or recreate the content for each different targeted format.

Content may also have been originally created for print or for traditional broadcast media or used in print, but later thought to be useful for use or presentation in different ways, such as on a computer screen, mobile phone screen, electronic time varying display, or the like. In creating this print content, it may have been created or printed specifically for a certain size, such as letter size. However, it may also be useful for presentation on postcard-size paper, A4 paper, PAL, NTSC, or the like, or in a different media type entirely, such as on a standard computer screen, mobile phone, electronic time varying display, or the like. In order to repurpose this content, content authors typically reshape or reformat the original layout to meet the size or layout restrictions of the new, targeted use, device, or media type. This process is significantly compounded when repurposing video as thousands of individual frames must be considered.

Creation and modification of such content is typically accomplished using computers and graphics design or page layout applications, such as Adobe Systems Incorporated's ACROBAT®, PAGEMAKER®, ILLUSTRATOR®, FREEHAND®, FRAMEMAKER®, FLASH®, AFTER EFFECTS®, PREMIERE PRO®, DREAMWEAVER®, GOLIVE®, Microsoft Corporation's FRONT PAGE®, and the like. The user generally creates, copies, opens, or scans the content into the development area and graphically generates or manipulates the content and layout to fit the desired target size or specific media presentation aspect for the targeted use. For example, if a company desires to create marketing pamphlets in various paper sizes and also for display on its websites, the author would create the graphics and other content for the pamphlet in an Integrated Development Environment (IDE), such as one of the design applications noted above, and then manipulate the graphics of the pamphlet to make it fit onto the desired target size or device in a pleasing or logical manner. Similar approaches are made when using or converting vide images. The author would generally use multiple editing sessions resulting in multiple files to accommodate all of the intended target formats. The resulting content would then be printed, stored, or placed into whatever other kind of medium or format for which it was intended.

Another relevant example is the purposing, i.e., creation or repurposing, of content for electronic devices, including personal computers (PCs), and mobile electronic devices, such as mobile phones, personal digital assistants (PDAs), portable media devices, such as Apple Computer Inc.'s IPOD®, Creative Technology Ltd.'s ZEN VISION™, iRiver Inc.'s CLIX™, and the like. As these electronic devices become more rich media capable, they become a natural place to consume time varying, interactive, and rich media information. Therefore, content authors are involved in creating new and repurposing existing content specifically for certain target electronic devices, such as target mobile electronic devices. Typically, content authors will make decisions on the layout, presentation, or format of information on a per device basis. With so many devices having multiple different presentation variables (e.g., different display sizes, etc.), there is a considerable amount of time designing and then fitting the designed content for multiple devices.

The wide variety of aspect ratios and resolutions available across various media today, and in particular, across mobile phones and other mobile devices creates an enormous number of variations for any content that is intended to reach multiple media devices. Because a developer purposing content for multiple media devices would generally create several hundred different variations of the content, content creation and repurposing is a very repetitive process that can be very tedious and time consuming. The potential costs to purposing content may, therefore, limit the amount of such authoring that is done and, as a result, reduce the potential benefit that new consumers may have in using content in multiple, different media. Moreover, the time constraints involved in bringing content to the market may result in coarse design decisions being made which may produce an inconsistent quality of information and content display. This approach to handling many target formats authors typically make single sets of decisions for multiple target devices. Such coarsely designed content may be too large or too small for a useful or pleasant user experience.

### BRIEF SUMMARY

The present invention and its various representative embodiments are directed to systems, methods, and computer program products that provide relevant information regarding the various purposing masks in an intuitive manner

Briefly, as disclosed in co-pending, commonly assigned U.S. patent application Ser. No. 11/512,567, Attorney Docket No. B266, entitled “IDENTIFICATION OF COMMON VISIBLE REGIONS IN PURPOSING MEDIA FOR TARGETED USE”. A content author may begin the design process by electronically sketching the content in a development environment. A content author typically makes creative decisions with a specific format in mind. For example, in order to make the design process more efficient, the author may use a mask that allows him or her to see the visual dimensions of the various presentation variables for the target media. The author will either create a mask or use a pre-built mask for each mobile device with a separate mask for each device having different presentation variables. The mask is then used as a layer over the content. Part of the mask is typically translucent or opaque, which represents the space outside of the usable display space on the mobile device. A portion in the center of the mask typically shows the visible space available on the device. In this manner, when the user lays the mask over the content, he or she is able to see what will generally be viewable by a person using that particular mobile device. Any part of the content that ends up behind the translucent or opaque section will be content that a user of that particular device would not typically be able to see. The developer may then make the necessary modifications to the content design to fit into the visible display area. Typically, the user either changes the content to make it fit the mask, or changes the crop/mask area on top of the content.

In order to keep track of the various masks and the associated formats that each mask represents, the user or developer typically relies on memory or customized names of either the mask or the layer in which the mask is placed. When working to purpose information into only a few different target formats, the ability to keep track of which masks represent the various target formats is relatively straight forward. However, when dealing with the purposing of information into tens or even hundreds of different target formats, keeping track of the various masks is extremely complicated, if not impossible in a single purposing session. A considerable amount of time is lost by repeating the purposing process with manageable groups of masks. This time expense would likely affect how many target formats are used for content to be purposed into. Thus, reducing the potential reach of information.

A user selects one or more target medium for the content being worked on in an integrated development environment (IDE). When these target mediums are selected, masks corresponding to the selected target media are displayed over the content. The IDE monitors the position information identifying a display location of each mask and/or a cursor position relative to a mask. When the user performs some kind of information event associated with an identified display location of one of the masks, the IDE detects this event and displays an information box that contains media type information regarding the target media related to the specific mask at the identified display location.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a block diagram illustrating a content purposing lifecycle;

FIG. 2A shows a screenshot illustrating a content purposing system configured according to one embodiment of the present invention;

FIG. 2B shows a screenshot illustrating a content purposing system configured according to one embodiment of the present invention;

FIG. 2C shows another screenshot illustrating a content purposing system according to one embodiment of the present invention;

FIG. 2D shows a screenshot illustrating a content purposing system configured according to an additional and/or alternative embodiment of the present invention;

FIG. 3 shows a screenshot illustrating a content purposing system configured according to one embodiment of the present invention;

FIG. 4 shows a screenshot illustrating a purposing environment configured according to one embodiment of the present invention;

FIG. 5 shows a flowchart illustrating exemplary operation according to one embodiment of the present invention; and

FIG. 6 shows a computer system adapted to use embodiments of the present invention.

### DETAILED DESCRIPTION

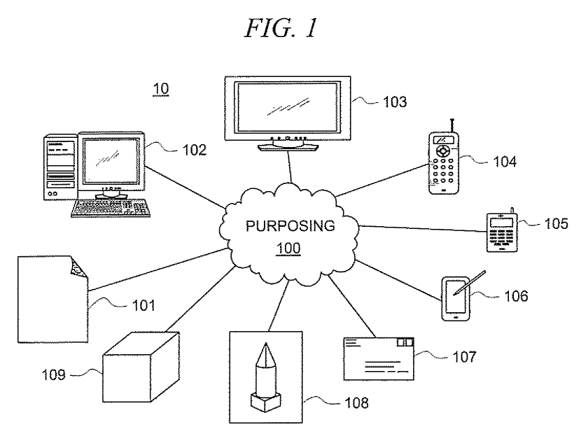

FIG. 1 shows a block diagram illustrating content purposing lifecycle 10. Content takes on many different forms and is represented in many different media or target formats. Such content may be presented on various media, such as print media, such as page 101 or postcard 107; computer media, such as computer 102, which may be electronic images or a complex Rich Internet Application (MA); television content, such as the content displayed on television 103; mobile device content, which may be displayed on mobile phones 104-110 and PDA 106; three-dimensional content such as hologram image 108 and block sculpture 109. Content, thus, is any type of information that is eventually presented in a physical or sensory manner, whether through electronic devices or non-electronic devices (e.g. physical material). As used herein below, medium (media or other derivation) refers to the device upon which the content is presented to a user.

In exemplary operation, a content author desires to create content for mobile phones 104 and 105 and also for PDA 106. Instead of working with three different content files that are specifically targeted for each of the devices, the content author selects to display masks representing mobile phones 104 and 105 and PDA 106 on to the design area of an IDE implementing content purposing process 100. For example, one such mask may provide a shaded region surrounding a clear region that represents the viewable area on the display of mobile phone 104, while the other masks provide similar transparent and translucent regions representing the viewable areas on mobile phone 105 and PDA 106. With each of the mask's transparent region intersecting into a common transparent region, the author may create the content to fit within the visible display areas of each of mobile phones 104 and 105 and PDA 106 by drafting the content within that common transparent region. Optionally, the content author may choose to include the majority of the content in the common transparent region, but allow some of the content to enter the overlapped translucent regions of selected ones of the target devices. For example, the author may design the content to fit squarely within the visible region of PDA 106, but allow some of the content to extend into the translucent regions of mobile phones 104 and 105. This extending of the content beyond the visible screen region of mobile phones 104 and 1135 may require the user of those mobile phones to use a scrolling function to view the entire content.

Use of such masks and exemplary development applications that provide the masks are described in more detail in co-pending, commonly assigned, U.S. patent application Ser. No. 11/512,567, Attorney Docket No. B266, entitled “IDENTIFICATION OF COMMON VISIBLE REGIONS IN PURPOSING MEDIA FOR TARGETED USE”, the disclosure of which is hereby incorporated by reference in its entirety. Thus, according to certain embodiments of the present invention masks may be provided into the IDE.

During the purposing process the user may desire to view information corresponding to a mask or croup of masks that are present in the IDE This information may include information such as devices associated with the mask, demographic information related to the users associated with the devices, etc. This information can be used by the user in making decisions and/or understanding the impact a particular purposing operation may have on the viewers of the media.

In purposing content for mobile devices, such as mobile phones 104-105, several mobile phone displays may share the same or similar sizing requirements. Thus, purposing content for 20 different mobile phones may not require the creation of 20 differently-sized pieces of content. A few differently-sized files may be used to provide content to all 20 or more mobile device displays.

In other circumstances, there may be content that is originally presented in a first medium that a content author desires to purpose for use in new medium. For example, if a content author desires to purpose the graphics content of a computer application that runs on computer 102 to adequately display on mobile phones 104-105 and PDA 106, he or she may use content purposing process 100 to crop, modify, and the like, the graphics content and user interface (UI) graphics to fit onto the screens of mobile phones 104-105 and PDA 106. In content purposing process 100, which is configured according to one embodiment of the present invention, the author may display the application graphics onto a design screen and select multiple purposing masks that were generated to show what portion of the application graphics will fit in the viewing area of the particular mobile device. The user of the development system may select to layer this purposing mask on top of the application graphics. Any of the graphics that remain visible through the transparent region would, therefore, be visible when presented on mobile phone 104. The user then either modifies, crops, or performs any other such editing on the images to accommodate the display size of mobile phone 104.

Additionally, the user could select to layer purposing masks that show the visible screen area for mobile phone 105 and PDA 106 on top of the mask representing the visible area of mobile phone 104. In this process, the user can see the visible display area that is common to all of mobile phones 104-105 and PDA 106. If the user desires to make a single content (e.g. application) that will be viewable on each of mobile phones 104-105 and PDA 106, he or she could then crop or modify the content (e.g. application and UI graphics), or copies thereon to fit in the common visible regions. In other approaches the user may make decisions that are optimal on one device and acceptable on other devices. For example, the user can choose a well framed shot on the phone with the largest field of view, but still have both full heads framed on those with narrower frames.

Content purposing may also be conducted in three-dimensions (3D) with physical items, such as block sculpture 109. Purposing 31 content may comprise representing the content in another target 3D media, such as another physical item, a holographic image, an orthographic projection, or some other kind of 3D perspective projection. In operation, a content author may scan or draw an electronic, 3D representation of block sculpture 109 into an IDE that implements content purposing process 100. The content author may then select the type and size of target medium desired, and a purposing mask or masks that represent those selected target medium would be layered on top of the scanned or drawn content. In the described example, the content author desires to create a hologram and a postcard that includes the image of block sculpture 109. Masks for both target medium and presentation variables would be layered on top of the scanned or drawn image of block sculpture 109, with the part of the image visible through the intersection of the transparent portions of the masks being the common region visible in both target mediums. The user may then crop, modify, rescale, or perform some other type of editing of the image to fit the resulting content into the target medium, i.e., hologram image 108 and postcard 107.

It should be noted that content purposing process 100 may be used to purpose content for any target formats, either through creating new content or repurposing existing content. It should further be noted that when operating content purposing process 100 with D) content, some 3D masks may be created from certain two-dimensional (2D) masks by extending the 2D mask into a 3D representation through an orthographic or other perspective projection.

When purposing content for some target forms of medium, such as electronic media (e.g., mobile devices), the target devices are not always uniform in display-size or resolution. Because there is no uniformity, multiple variations of purposed content are typically created in order to conform to each of the presentation variables of the various target devices, such as display size, aspect ratio, density, pixel shape, resolution, and the like. Alternatively, a content author could select to purpose content to a certain single set of presentation variables, but do so in such a fashion that would accommodate the most devices possible. In other words, fewer versions of the content may be created if one or more of the versions are created (or purposed) such that they are suitable for presentation on multiple different device types (e.g. having different presentation variables).

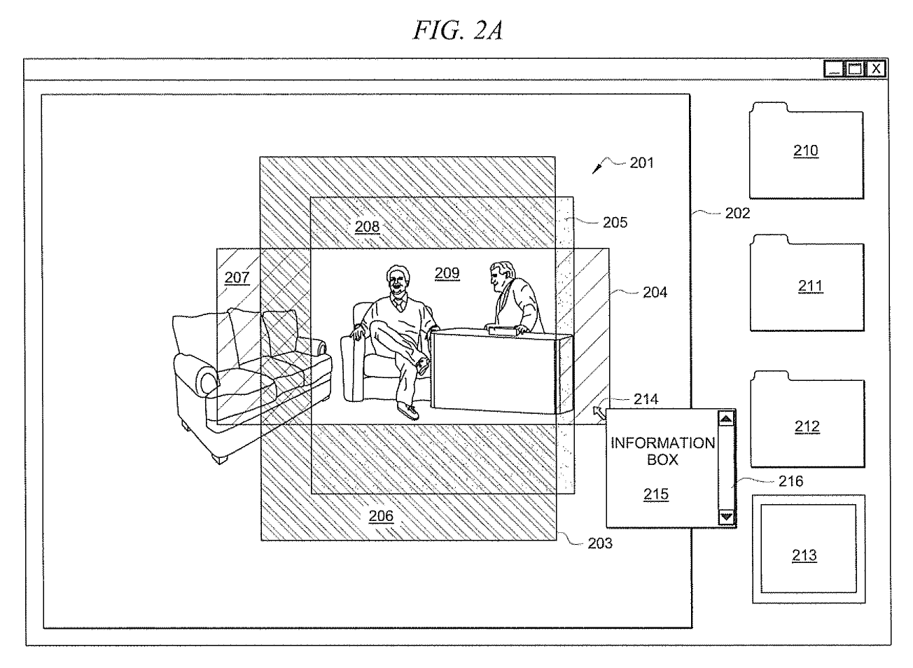

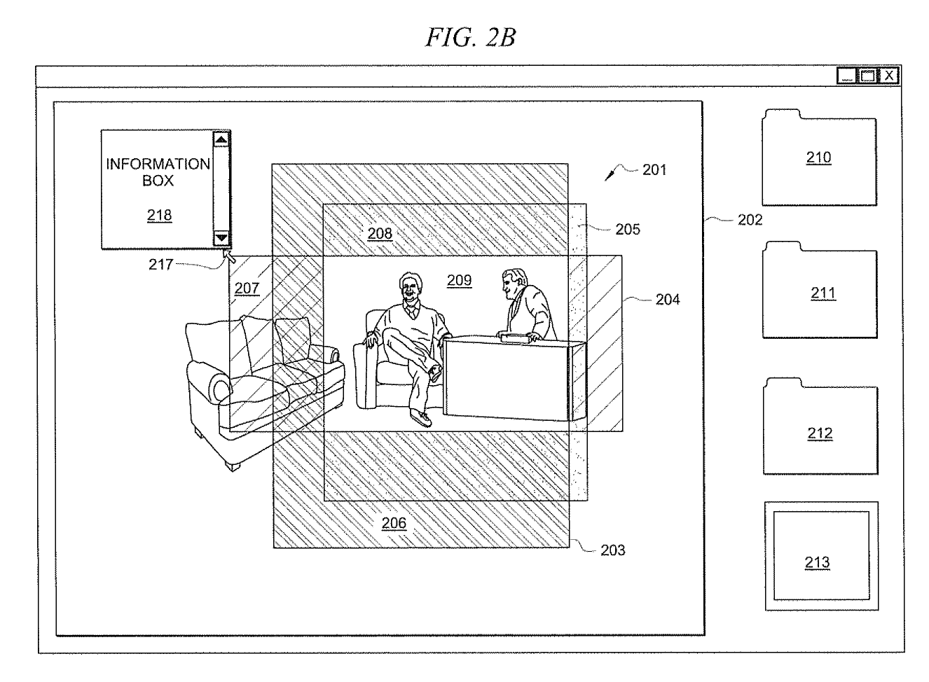

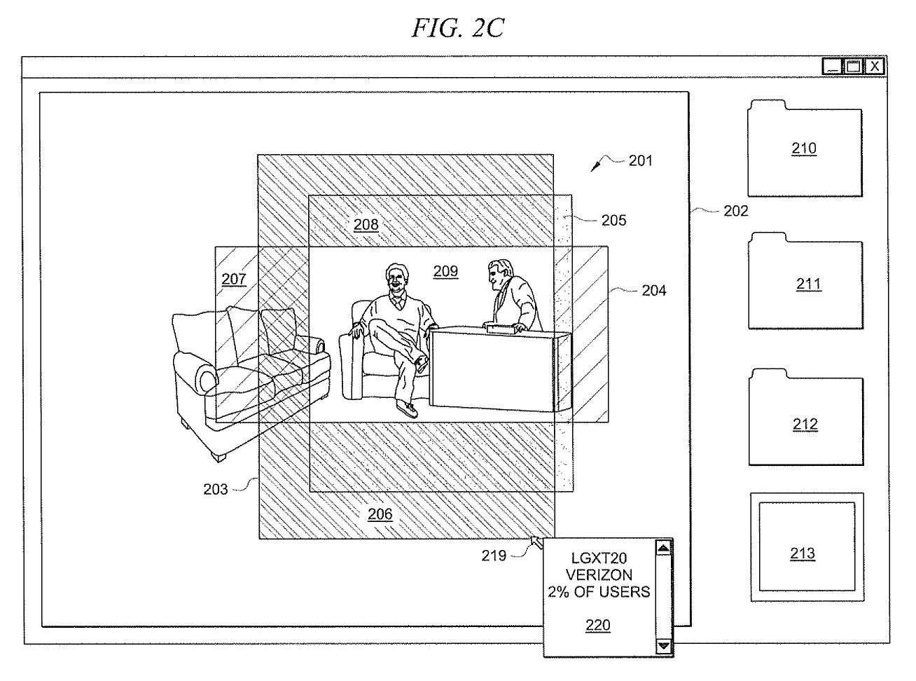

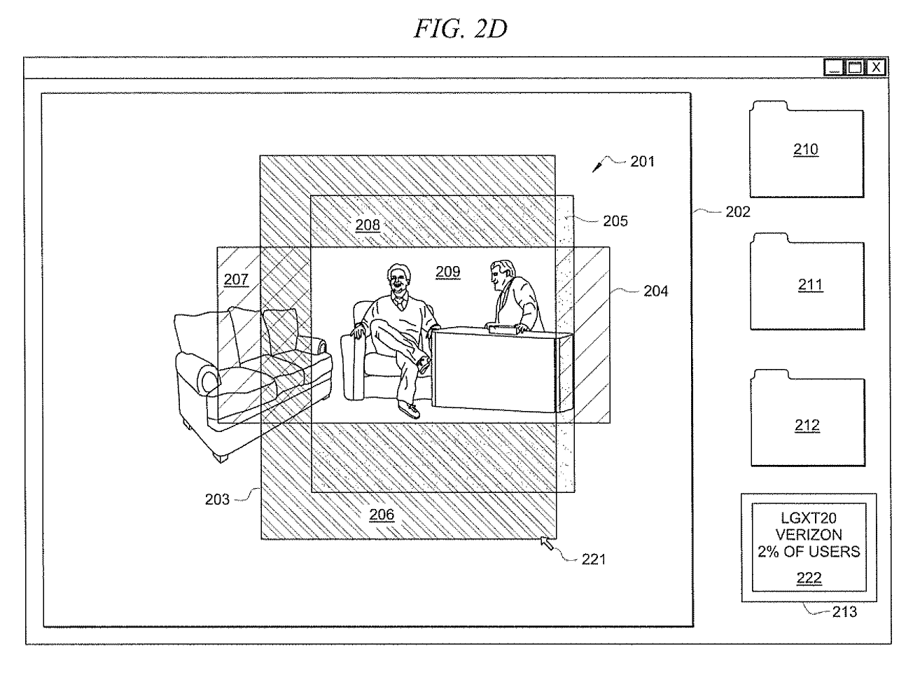

FIG. 2A is a screenshot illustrating content purposing system 20 configured according to one embodiment of the present invention. Content purposing system 20 is implemented through IDE 200. IDE 200 uses typical interface features, such as tool panels 210-212, property inspector 213, and design canvas 202. For purposes of this example, a content author desires to purpose content 201, which reads “GO Mobile,” for use oil a number of mobile phone devices. While this example allows the user to purpose content for mobile phone devices, the content purposing system may likewise be used to additionally or alternatively purpose content for other media types. The author begins, in this example by placing content 201 onto design canvas 202. Using a pull-down menu or one of tool panels 210-212, which may be assigned for content purposing, the author selects to purpose content 201 to a mobile device and selects the actual mobile phone device model or group of mobile devices that share the same display dimensions, such as for mobile phone 104 (FIG. 1). Once selected, purposing mask 203, which represents the display dimensions of mobile phone 104, is layered on top of content 201. Purposing mask 203 provides a transparent region, defined by transparent region 206, that represents the display dimensions of mobile phone 104 (FIG. 1). The author then selects two additional purposing masks, purposing masks 204 and 205, which lay directly on top of purposing mask 203. Purposing masks 204 and 205 provide transparent regions 207 and 208, respectively, and represent the display dimensions for additional mobile phones that the author desires to purpose content 201 for.

As transparent regions 206-208 either do not overlap or overlap fewer than all of the transparent regions of purposing masks 203-205, some kind of visual indicator, such as shading, is applied to the portion of transparent regions 206-208 that do not share a totally common area. The portion common to all of transparent regions 206-208, however, remains transparent, as represented by common visible region 209. This identification of the common visible region shared by each of the purposing masks is described in co-pending and commonly-assigned U.S. patent application Ser. No. 11/512,567, Attorney Docket No. B266, entitled “IDENTIFICATION OF COMMON VISIBLE REGIONS IN PURPOSING MEDIA FOR TARGETED USE,” the disclosure of which is hereby incorporated herein by reference. By having the common display regions identified through common visible region 209, the author is then able to position or edit content 201 in such a way so as to make content 201 visible in each of the desired mobile devices represented by purposing masks 203-205.

When purposing or re-purposing content for use on multiple, specific mobile devices, content authors typically must either remember which mask is associated with which particular device or provide a name to the mask that might indicate its related device. If the author used one mask per device and did not contemplate purposing for many different devices, these methods could be used to keep track of the purposing exercise. However, in practice, there are a number of different phones, from different manufacturers, that have the same physical screen dimensions or “aspect ratio”. Moreover, when a mobile content author desires to obtain the widest possible audience for his or her content, the author will typically be purposing or re-purposing that content for many different display sizes. This volume of different devices and display sizes makes it difficult for the author to either use his or her memory or naming of the masks as a viable way to maintain organization of the purposing exercise. IDE 200, configured according to one embodiment of the present invention, offers a solution to the author. In sonic embodiments the user can specify a set of target mediums and the corresponding masks or set of masks can be provided. For example, the user could request for all mobile phones used by a service provider, or all phones associated with a desired demographic (such as devices used by 13 year old girls).

If the content author desires to find out what mobile devices are represented by any particular purposing mask, he or she moves cursor 214 over the portion of the transparent region shared only by that particular purposing mask. For example, FIG. 2A illustrates cursor 214 hovering over the transparent region of purposing mask 205, i.e., shaded transparent region 208. As the author hovers cursor 214 over shaded transparent region 208, information box 215 pops up which contains a listing of each specific mobile phone or mobile device represented by purposing mask 205. In certain instances, many different devices may be represented, thus, causing a scrolling mechanism, such as scroll bar 216 to be provided for the user to scroll through the list. In some embodiments to aid in clarity, lists can be sub-setted (e.g., only show devices having a specific demographic range. In this manner, the user may easily find out which devices (or other information related to the mask) are represented by a particular purposing mask.

FIG. 2B is a screenshot illustrating content purposing system 20 configured according to one embodiment of the present invention. In this example, the author desires to know which devices are represented by purposing mask 204. Cursor 217 is moved to hover over transparent region 207. Information box 218 appears displaying the make and model number of each device represented by transparent region 207. In FIG. 2C, which is another screenshot illustrating content purposing system 20, the author has moved cursor 219 to hover over transparent region 206. When cursor 219 so hovers, information box 220 pops up listing the single device make and model represented by purposing mask 203. Information box 220 displays that an LG XT20 model mobile phone display is represented by transparent region 206 of purposing mask 203. Thus, by hovering the cursor over specific portions of the displayed purposing masks, the author or developer has ready access to the exact mobile phone models represented by each of the masks.

FIG. 2D is a screenshot illustrating content purposing system 20 configured according to an additional and/or alternative embodiment of the present invention. In the embodiments described with respect to FIGS. 2A-C, as the author hovered over the respective areas, an information box popped up within the viewing area of design canvas 202. In the additional and/or alternative embodiment of the present invention illustrated in FIG. 2D, as the user or author positions cursor 221 over a specific transparent area, such as transparent region 206, and selects that area, information box 222 appears in property inspector 213.

It should be noted that in various additional and/or alternative embodiments of the present invention, the information with regard to the specific target device or medium may be displayed or presented to the user in various and multiple locations, the present invention is not limited to display only through popup boxes within the design canvas or presentation on the property inspector.

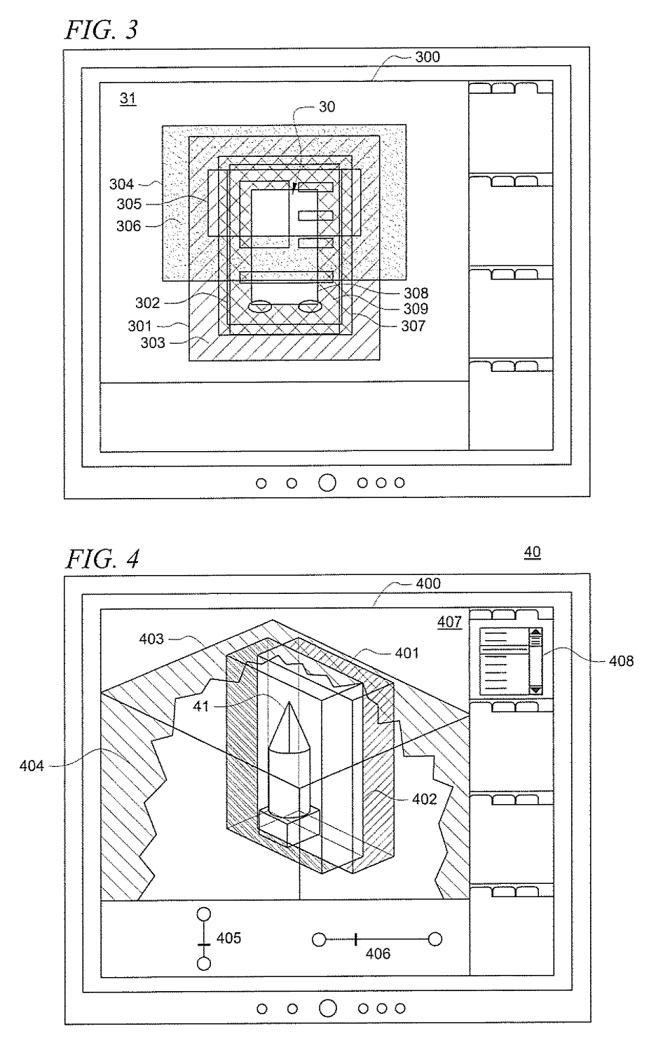

FIG. 3 is a screenshot illustrating content purposing system 30 configured according to one embodiment of the present invention. A user may also desire to purpose various pieces of content for various different types of mediums. In the example embodiment illustrated in FIG. 3, content 31 is displayed on design canvas 32 of IDE 300. The user desires to purpose content 3 I, not only for display on a PDA, but for a 4″×6″ postcard to use in an advertising campaign. In order to preview the viewing area of the PDA and postcard in relation to content 31, the user selects to overlay mask 301 onto design canvas 32. Mask 301 includes transparent region 302. The user then selects to add masks 306 and 307 for purposing content 31 to additional medium types, which creates common visible region 303. Once all the masks have been overlayed onto design canvas 32, the user can easily determine the type of medium that each of masks 301, 306, and 307 represent. The user positions cursor 304 over the shaded area of mask 301 and activates a special selector, such as the right mouse button, a function key, shortcut; or the like. In response to this selector activation, information box 305 pops onto the display of IDE 300. Information box 305 displays the mediums represented by mask 301, an HP IPAQ® 360 an a 4″×6″ postcard.

FIG. 4 is a screenshot illustrating purposing environment 40 configured according to one embodiment of the present invention. In addition to handling typical 2 dimensional (2D) media, various embodiments of the present invention may also handle purposing 3-dimensional (3D) media. 3D object 41 is represented on design canvas 407 of IDE 400. Using rotation tabs 405 and 406, the user can rotate the view perspective of 3D object 41. The user desires to plan manufacture of 3D object 41 in several different materials. Each material may require certain size or dimensions in order to provide a specific stiffness or hardness or other structural requirement. IDE 400 includes special software created for such manufacturing design tasks. The user accesses materials list 408 to select the materials he or she desires to use for 3D object 41. After selecting each of the desired materials, a 3D mask is displayed over 3D object 41. For example, 3D masks 403 and 404 are overlayed onto 3D object 41 with transparent regions 401 and 402. Because the 3D masks would typically have the transparent regions in the middle of the non-transparent area, a section of the shaded or non-transparent area is removed in the line-of-sight between the user and 3D object 41. With this section removed, the user can then see the intersection of transparent regions 401 and 402 at common target region 411. If the user were to rotate the view of 3D object 41, the portion of the non-transparent removed would also change to provide an unrestricted view of common target region 411 from the user's point-of-view.

Once the desired masks are placed onto design canvas 407, the user may find out which masks represent the various materials that were selected from materials list 408. By hovering cursor 409 over transparent area 402, information box 410 pops up showing that transparent area 402 represents the dimensions that will be used for plaster and also for concrete. Thus, the user will have ready availability of the specific material associated with each of the masks that have been placed onto design canvas 407.

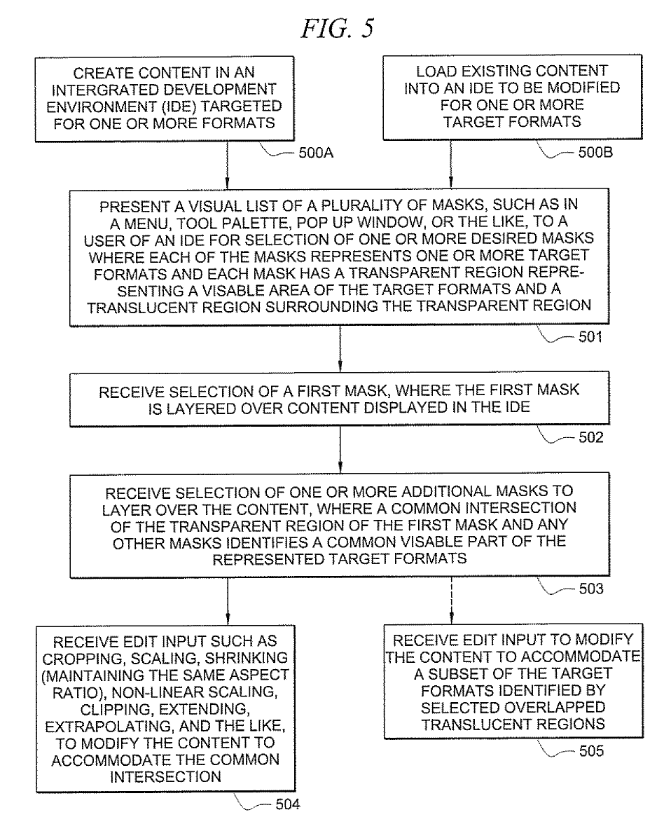

FIG. 5 is a flowchart illustrating example steps executed to implement one embodiment of the present invention. Because the content purposing system of the present invention may be used in creating targeted content or repurposing existing content into a new targeted format, there are alternative beginning steps. In step 500A, a content author begins creation of content targeted for one or more formats in an IDE. In step 500B, a content author loads existing content that is designated to be modified for one or more formats. In step 501, a visual list of a plurality of masks, such as in a menu, tool palette, pop-up window, or the like, is presented to a user of an IDE for selection of one or more desired masks where each of the masks represents one or more target formats and each mask has a transparent region representing a visible area of the target formats and a translucent region surrounding the transparent region. Selection of a first mask is received, in step 502, where the first mask is placed in a separate layer than the content displayed in the IDE. Selection of one or more additional masks is received, in step 503, to place in yet another layer separate from the content and the first mask, where a common intersection of the transparent region of the first mask and any other masks identifies a common visible part of the represented target formats. In step 504, edit input is received such as cropping, scaling, shrinking (maintaining the same aspect ratio), non-linear scaling, clipping, extending, extrapolating, and the like, to modify the content to accommodate the common intersection.

It should be noted that in alternative step 505, edit input is received to accommodate a subset of target formats that are identified by selected overlapped translucent regions. By selecting the subset of target formats, the content author modifies the content to fit within the visible regions of those target formats.

The program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (m+) link, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

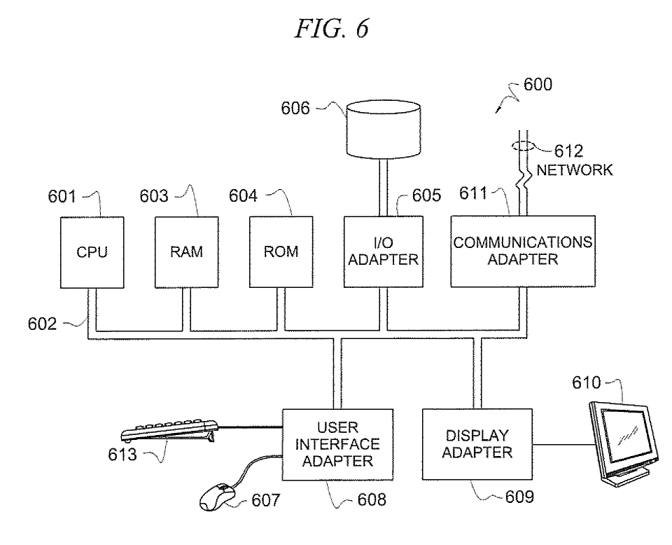

FIG. 6 illustrates computer system 600 adapted to use embodiments of the present invention, e.g. storing and/or executing software associated with the embodiments. Central processing unit (CPU) 601 is coupled to system bus 602. The CPU 601 may be any general purpose CPU. However, embodiments of the present invention are not restricted by the architecture of CPU 601 as long as CPU 601 supports the inventive operations as described herein. Bus 602 is coupled to random access memory (RAM) 603, which may be SRAM, DRM, or SDRAM. ROM 604 is also coupled to bus 602, which may be PROM, SPROM, or EEPROM. RAM 603 and ROM 604 hold user and system data and programs as is well known in the art.

Bus 602 is also coupled to input/output (110) controller card 605, communications adapter card 611, user interface card 608, and display card 609. The I/O adapter card 605 connects storage devices 606, such as one or more of a hard drive, a CD drive, a floppy disk drive, a tape drive, to computer system 600. The consumer identification information and/or media type information may be stored locally in such storage devices 606. When the system is triggered to display the consumer identification or media type information, it may access storage devices 606 for this information. The I/O adapter 605 is also connected to a printer (not shown), which would allow the system to print paper copies of information such as documents, photographs, articles, and the like. Note that the printer may be a printer (e.g., dot matrix, laser, and the like), a fax machine, scanner, or a copier machine. Communications card 611 is adapted to couple the computer system 600 to a network 612, which may be one or more of a telephone network, a local (LAN) and/or a wide-area (WAN) network, an Ethernet network, and/or the Internet network. In addition to retrieving the consumer identification and media type information from a local storage, such as storage devices 606, the system may also retrieve such information from a remote storage (not shown) or network application (not shown) via the network or Internet. The system transmits a request for this information via communications card 611 over network 612, and then receives the information through the same communications card 611. User interface card 608 couples user input devices, such as keyboard 613, pointing device 607, and the like, to the computer system 600. User interface card 608 also provides a means for a user to manually enter the consumer identification or media type information for use in the system. The system may use all, one, or any combination of these means for retrieving the consumer identification and/or media type information. The display card 609 is driven by CPU 601 to control the display on display device 610.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method comprising:
displaying a plurality of masks over content displayed in a design canvas of an integrated development environment (IDE), each one of said plurality of masks representing one or more target media, the plurality of masks displayed at the same time in the design canvas, and at least one of the masks representing a target medium different from a target medium represented by at least one other mask;
while the plurality of masks are displayed, receiving position information identifying a location in said design canvas;
detecting an information event associated with the identified location; and
displaying an information box responsive to said information event, said information box having information regarding said one or more target media related to one of said plurality of masks at said identified display location.

2. The method of claim 1 further comprising
receiving selection input identifying a specific media type to purpose said content, wherein said displaying said plurality of masks is responsive to said receiving said selection input, and wherein dimensions of said specific media type are represented in said one or more masks.

3. The method of claim 1 further comprising:
displaying a list of specific media.

4. The method of claim 3 wherein said list is displayed in one or more of:
a drop down menu;
a dialog box;
a tool palette; and
a property inspector.

5. The method of claim 2 wherein said receiving selection input identifying said specific media type further comprises:
receiving an indication of a specific demographic into which to purpose said content.

6. The method of claim 1 wherein said information event comprises one or more of:
hovering a cursor over said identified location; or
selecting a mouse button while said cursor is over said identified location.

7. The method of claim 1 wherein said
information regarding said one or more target media related to one of said plurality of masks at said identified display location comprises one or more of:
a commercial product name;
a common name for a type of media; and
a description of said one or more target media.

8. The method of claim 1 further comprising:
retrieving said information regarding said one or more target media related to one of said plurality of masks at said identified display location from one or more of:
a local electronic storage;
a remote electronic storage;
a network application accessible via a network.

9. The method of claim 8 further comprising:
receiving periodic updates of said media type information to said local electronic storage.

10. The method of claim 8 wherein said retrieving fuirther comprises:
retrieving said media type information entered into said local electronic storage.

11. A method comprising:
monitoring a plurality of user actions within a workspace of an integrated development environment (IDE);
detecting an information event related to one of one or more dimension masks, wherein said one or more dimension masks are layered over content displayed on said workspace; and
responsive to said information event, displaying consumer identification information with regard to one or more target media formats represented by said one of said one or more dimension masks.

12. The method of claim 11 wherein detecting said information event comprises one or more of:
detecting a cursor hovering over a location of said one of said one or more dimension masks;
detecting selection of a pointing device button while said cursor is situated over said location; and
detecting selection of a special key sequence associated with triggering said displaying said consumer identification information.

13. The method of claim 11 wherein said displaying said consumer identification information comprises one or more of:
rendering a popup tip box containing said consumer identification information;
displaying said consumer identification information in a tool palette; and displaying said consumer identification information in a property inspector.

14. The method of claim 11 further comprising:
retrieving said consumer identification information from one or more of:
a local electronic storage;
a remote electronic storage; or
a network application accessible via a network.

15. The method of claim 14 further comprising:
receiving periodic updates of said consumer identification information to said local electronic storage.

16. The method of claim 14 wherein said retrieving further comprises:
retrieving said consumer identification information entered into said local electronic storage.

17. A computer program product having a non-transitory computer readable medium with computer program logic recorded thereon, said computer program product comprising:
code for simultaneously displaying a plurality of masks over content displayed in an integrated development environment (IDE), each of said plurality of masks representing one or more target media;
code for receiving position information identifying a display location;
code for detecting an information event associated with one of said one or more masks based on the display location; and
code for displaying an information box responsive to said information event, said information box having media type information regarding said one or more target media related to said one of said one or more masks at said identified display location.

18. The computer program product of claim 17 further comprising:
code for receiving selection input identifying a specific media type to purpose said content, wherein said code for displaying said one or more masks is responsive to said code for receiving said selection input, and wherein dimensions of said specific media type are represented in said one or more masks.

19. The computer program product of claim 18 further comprising:
code for displaying a list of specific media.

20. The computer program product of claim 19 wherein said list is displayed in one or more of:
a drop down menu;
a dialog box;
a tool palette; and
a property inspector.

21. The computer program product of claim 18 further comprising:
code for receiving an input indicative of a specific demographic into which to purpose said content.

22. The computer program product of claim 17 wherein said code for detecting comprises one or more of:
code for detecting a cursor hovering over said identified display location;
code for detecting selection of a mouse button while said cursor is over said identified display location; and
code for detecting selection one of said one or more masks associated with a desired one of said one or more target media.

23. The computer program product of claim 17 wherein said media type information comprises one or more of:
a commercial product name;
a common name for a type of media; and
a description of said one or more target media.

24. The computer program product of claim 17 further comprising; code for retrieving said media type information from one or more of:
a local electronic storage;
a remote electronic storage;
a network application accessible via a network.

25-30. (canceled)

31. A computing system, comprising:
a processor; and
a memory,
wherein the memory embodies program components that configure the computing system to:
provide a display canvas,
display content in the display canvas,
display a plurality of masks, the plurality of masks displayed simultaneously and overlaying the content,
receive input identifying one of the plurality of masks, and
in response to the input, display an information box indicating one or more target media associated with the identified one of the plurality of masks.

32. The system set forth in claim 31, wherein the input identifying one of the plurality of masks comprises position information identifying a display location in the design canvas, wherein the one of the plurality of masks is identified by determining which one of the plurality of masks is the only one of the plurality of masks at the display location.

33. The system set forth in claim 31, wherein the information box identifies a type of device associated with the identified one of the plurality of masks.

34. The system set forth in claim 31, wherein the computing system is configured to display the plurality of masks in response to input identifying a plurality of different media for repurposing content, at least one of the identified media including a mobile device.

35. The system set forth in claim 31,
wherein each of the plurality of masks, when displayed, defines a transparent region representing a display area of the one or more media associated with the mask, and
wherein when the plurality of masks are displayed together, a visual indicator is applied to the portion of the transparent regions that are not common to all of the masks.

36. The method set forth in claim 11,
wherein said one or more dimension masks comprise a plurality of different dimension masks layered over content displayed on said workspace, the plurality of different dimension masks displayed at the same time, and
wherein the detected information event is determined to be related to one of the dimension masks based on position information identifying a display location, with the one of the dimension masks at the display location being the dimension mask determined to be related to the information event.
